(19) United States
(12) Patent Application Publication
(10) Pub. No.: US 2009/0052763 A1
(43) Pub. Date: Feb. 26, 2009

(54) Characterization of lung nodules

(76) Inventors: Mausumi Acharyya, Bangalore (IN); Sumit Chakravarty, Baltimore, MD (US); Jonathan Stoeckel, RB Hierden (NL)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/132,365

(22) Filed: Jun. 3, 2008

Related U.S. Application Data
(60) Provisional application No. 60/941,801, filed on Jun. 4, 2007.
(60) Provisional application No. 60/941,826, filed on Jun. 4, 2007.
(60) Provisional application No. 60/941,811, filed on Jun. 4, 2007.

(51) Int. Cl. G06K 9/00

(52) U.S. Cl. 382/132

(57) ABSTRACT

A method of identifying nodules in radiological images, said method comprising: (a) obtaining a radiological image; (b) selecting a sub-image centered around a candidate location; (c) dividing the sub-image into a rectangular array of cells; (d) calculating absolute values of Intensity Differences id₍ₖ₎ according to a Fractional Brownian Motion (FBM) calculation equation:

$${id}_{( k )} = [ \begin{matrix}\frac{{\sum }_{x = 0}^{N - 1} {\sum }_{y = 0}^{N - k - 1} \vert I ( x , y ) - I ( x , y + k ) \vert}{4 N ( N - k )} + \\ \frac{{\sum }_{y = 0}^{N - 1} {\sum }_{x = 0}^{N - k - 1} \vert I ( x , y ) - I ( x + k , y ) \vert}{4 N ( N - k )} + \\ \frac{{\sum }_{x = 0}^{N - 1 - k} {\sum }_{y = 0}^{N - k - 1} \vert I ( x , y ) - I ( x + k , y + k ) \vert}{4 {( N - k )}^{2}} + \\ \frac{{\sum }_{x = 0}^{N - 1 - k} {\sum }_{y = 0}^{N - k - 1} \vert I ( x , N - y ) - I ( x + k , N - ( y + k ) ) \vert}{4 {( N - k )}^{2}}\end{matrix} ] ,$$

for k=1 to s; (e) calculating a NFBM feature, f₍ₖ₎, for each id₍ₖ₎: f₍ₖ₎=log(id₍ₖ₎)−log(id₍₁₎; (f) integrating f₍ₖ₎, over k=1 to s; (i) classifying the cells into intensity contrast classes, according to intensity contrast between each cell and its neighbors, and the integration result; (k) remapping each cell of the sub-image according to its contrast class, and (m) determining the shape of the region of high-contrast cells in the sub-image, wherein an annular shape identifies a nodule.

### CROSS REFERENCE TO RELATED APPLICATION

The present application claims priority rights from U.S. Provisional Application No. 60/941,801, filed Jun. 4, 2007; U.S. Provisional Application No. 60/941,826, filed Jun. 4, 2007; and U.S. Provisional Application No. 60/941,811, filed Jun. 4, 2007.

### FIELD OF THE INVENTION

The present invention relates to techniques for computer aided diagnosis, and particularly for the diagnosis of nodules in lung x-ray radiographs.

### BACKGROUND

The chest x-ray is the most commonly performed x-ray examination procedure. The heart, lungs, airway, blood vessels and the bones of the spine and chest are imaged in a painless medical test that helps in the diagnosis of medical conditions.

The chest x-ray is typically the first imaging test used to help diagnose causes of symptoms such as shortness of breath, fever, a bad or persistent cough, chest pain or injury. Its application helps in diagnosing and monitoring treatment for medical conditions such as pneumonia, lung cancer, emphysema, heart failure and other heart problems. It may be used to find fractures in ribs as well.

Pneumonia shows up on radiographs as patches and irregular lighter areas due to fluid in the lungs which absorb greater amounts of x-ray than the air filled, less x-ray stopping lung tissue. If the bronchi, which are usually not visible, can be seen, a diagnosis of bronchial pneumonia may be made. Symptoms indicative of possible pulmonary diseases may be revealed through chest x-rays. For example, shifts or shadows in the hila (lung roots) may indicate emphysema or a pulmonary abscess. Likewise, widening of the spaces between ribs suggests emphysema.

Lung cancer claims more victims than breast cancer, prostate cancer and colon cancer do together. The 5-year survival rate has remained for the past 30 years at just 15% due to the lack of diagnosable symptoms in the afflicted until advanced stages of the illness.

Lung cancer usually shows up as some sort of abnormality on the chest radiograph. Hilar masses (enlargements at that part of the lungs where vessels and nerves enter) are one of the more common symptoms as are abnormal masses and fluid buildup on the outside surface of the lungs or surrounding areas. Interstitial lung disease, which is a large category of disorders, many of which are related to exposure of substances (such as asbestos fibers), may be detected on a chest x-ray as fiber like deposits, often in the lower portions of the lungs.

One of the main reasons for carrying out chest x-ray examinations is to identify lung nodules. Nodules are more or less spherical aggregations of abnormal cells, and may indicate lung cancer. The x-ray shadow of lung nodules shows up in chest radiographs as nearly spherical whiter regions on the darker lung tissue. An x-ray radiograph is an integration of the absorption of x-rays of all the body tissue between the x-ray source and the detecting material, which includes breast tissue, ribs and other bones, lung tissue and the like.

It is not easy to isolate nodules in x-ray radiographs because of the x-ray shadows of other structures, such as rib shadows and shadows from major blood vessels, which may be superimposed thereover.

Once a nodule is detected, it may be analyzed and identified as being malignant or benign, often requiring a biopsy to do so. Diagnosis of cancer and other medical conditions by analysis of x-ray radiography images may be difficult, slow and be unreliable, leading to a high incidence of false positives, where shadows not due to nodules are mistakenly identified as being nodules. Such spurious results are problematic. However false negatives, where actual nodules or tumors are not identified are more serious.

A skilled radiographer may manually identify nodule shadows in x-ray radiographs, but, even nodules as large as 5-10 mm nodules are easily overlooked [N. Wu, et al., “Detection of small pulmonary nodules using direct digital radiography and picture archiving and communication systems”, J. Thorac. Imaging, 21(1), 2006, pp. 27-31.]. A computer aided diagnostic (CAD) system, when used in conjunction with a radiologist, appears to improve the ability to detect lung cancer by up to 50% for early detection of nodules [http://en.wikipedia.org/wiki/Computer-aided_diagnosis], down to a size of 1 mm [B. Van Ginneken et al., “Computer-aided diagnosis in chest radiography: a survey”, IEEE Trans. Med. Imag., 20, 2001, pp. 1228-1241]. Not only is the sensitivity better, but the processing times are typically faster, allowing better use of resources.

Nodules are difficult to detect by CAD technologies [T. Wollenweber et al., “Korrelation zwischen histologischem befund und einem Computer-assistierten Detektion system (CAD) für die Mammografie”, Gerburtsh Frauenhelik, 67, 2007, pp. 135-141]. Even after processing the radiographs by prior art methods [S. Lo, M. Freedman, J. Lin, and S. Mun, “Automatic lung nodule detection using profile matching and back-propagation neural network techniques”, J. Digital Imag., 6, 1993, pp. 48-54; W. Lampeter, “Ands-v1 computer detection of lung nodules”, in Proc. SPIE, 1985, pp. 253-e; Y. Lee, T. Hara, H. Fujita, S. Itoh, and T. Ishigaki, “Automated detection of pulmonary nodules in helical CT images based on an improved template-matching technique”, IEEE Trans. Medical Imaging, 20(7), 2001, pp. 595-6041, nodules may still show up as low-contrast white circular structures with physically indistinct boundaries, and present day CAD systems have limited reliability.

Computer aided diagnosis relies on hypothesizing suspected nodules, henceforth candidates, and extracting features from the x-ray radiograph that characterize such candidates. Empirical models, essentially numerical algorithms, are developed for classifying the candidates as being nodules or non-nodules, based on such features.

There is an ongoing effort to improve the performance of CAD algorithms for lung cancer diagnosis and other applications, such as mammography for example. Improvement programs focus generally on extracting new features and in modifying the way the features are combined in a classifier in order to raise their statistical significance.

The performance of the classifier may also be improved through combination of the extracted features into more effective algorithms.

Generally, the prior art image processing methods used for analyzing radiological images require some initial setting of parameters by the user, which renders the methods labor-intensive and lengthy. It will be appreciated that all methods that require initializing by manually setting parameters by the user, introduce an element of bias into the results. In an effort to minimize the setup procedures, some random process inspired methods, for example the Hidden Markov Model, have been used to for detection of nodules in lungs, see, for example, U.S. Pat. No. 6,549,646 to Yeh et al. titled “Divide-and-conquer method and system for the detection of lung nodule in radiological images”.

Malignant nodules tend to have poorly defined edges, and the x-ray shadows thereof lack clear boundaries, which makes their detection difficult. The central regions are comparatively homogeneous with stronger shadow, and appear white. The edge regions are intermediate in density. If a sub-image containing a candidate nodule is divided into sub-areas, one feature that may usefully be extracted is a measurement of ‘texture’—the variation in shadow density between adjacent sub areas. This is indicative of both the diffuse nature of nodule edges, and the fact that the contrast between the x-ray shadow of edges and surrounding tissue is minor as the depth of the spherical nodule drops off towards the edges, creating a smaller obstruction to x-rays. It has been noted, that manually deciding where edges are introduces an element of bias, and in comparing adjacent regions, a randomizing process, such as a Brownian motion algorithm may be used to overcome this phenomenon.

Mandelbrot [B. Mandelbrot, “The Fractal Geometry of Nature” (Hardcover—1983), W. H. Freeman & Co., San Francisco, USA] introduced the Fractional Brownian Motion (FBM) model to measure the texture of images. A modification of this model, Normalized Fractional Brownian Motion (NFBM), has been successfully used to diagnose abnormalities in liver from ultrasonic images of the same [C. Chen, J. Daponte, and M. Fox, “Fractal feature analysis and classification in medical image”, IEEE Trans. Med. Imag., 8, pp. 133-142, 1989; C. Wu, Y. Chen and K. Hsieh, “Texture feature for classification if ultrasonic liver images”, IEEE Med. Imag., 11, 1992, pp. 141-152.]

Lung cancer is the major type of terminal cancer in developed countries, and a similar trend is emerging in the developing countries as well. In Finland, as in the USA, lung cancer is the number one cause of cancer deaths, being responsible for 19% of all cancer deaths and 4% of all deaths in Finland (Statistics Finland 1999) and for 28% and 6% respectively, in the USA (Beckett 1993). The five-year survival rate for all cases of lung cancer was 6% in 1950-1954 and 13% in 1981-1987 (Beckett 1993), so although some improvement in survival rates has occurred, there is room for further improvement.

The likelihood of developing lung cancer is strongly associated with exposure to cigarette smoking. However since only a fraction (10-20%) of lifetime smokers develop lung cancer, it is likely that genetic factors may also affect individual susceptibility.

In addition to tobacco, another main cause of cancer is asbestos, a naturally occurring rock consisting of magnesium and calcium silicates, which was widely used in the construction industry before its dangers were recognized.

Lung cancer manifests itself by the appearance of nodules within the lung. Not all nodules are cancerous however, and the main characterizing features of benign and malignant nodules are briefly summarized hereinbelow.

Benign nodules typically have some of the following characteristics:
1. Lesions, which include central, lamellar or rim calcification;
2. Lesions that resolve, improve or remain stable over time;
3. Small smooth lesions having well-defined margins;
4. Benign cavitary nodules generally have smooth, thin walls;
5. Cavitary nodules having a wall thickness less than 4 mm are usually benign;
6. The presence of calcification in a solitary pulmonary nodule also indicates that such a nodule is benign. There are four benign patterns of calcification: “central”, “diffuse”, “solid laminated” and “popcorn”. The first three patterns are typically seen with prior infections, particularly histoplasmosis or tuberculosis. Popcorn like calcification is characteristic of chondroid calcification in a hamartoma.

In contradiction, malignant nodules are usually characterized by some of the following features:
1. Lesions, which include invasion and adenopathy;
2. Lesions that enlarge over time;
3. Lobulated contours as well as an irregular or speculated margin with distortion of adjacent vessels;
4. Nodules typically have thick, irregular walls;
5. Nodules with a wall thickness greater than 16 mm;
6. Calcification in lung cancer is rarely observed at chest radiography but is seen at CT in up to 6% of cases; such calcification is typically diffuse and amorphous. Punctuate calcification may also occur in lung cancer due to engulfment of a preexisting calcified granulomatous lesion and metastases.

The second edition of the WHO histological typing of lung tumors, which was published in 1981 (WHO 1981), is the most widely used classification system for lung nodules. The classification is based on optical microscopy criteria. Common lung neoplasm may be classified by the best-differentiated region of the tumor and graded by the most poorly differentiated area. Lung cancers are divided into two main groups on the basis of their histology and clinical features, namely Small Cell Lung Cancer (SCLC) and Non-Small-Cell Lung Cancer (NSCLC).

Small Cell Lung Cancer accounts for fifteen percent of all diagnoses, and is most prevalent among smokers. Small Cell Lung Cancer is also called oat cell cancer, because malignant cells are oat-shaped. Small Cell Lung Cancer is aggressive, and spreads quickly. In approximately seventy percent of cases the cancer has spread to other organs by the time the disease is diagnosis. Once metastasized, a Small Cell Lung Cancer patient is not a candidate for surgery but does respond to chemotherapy.

Non-Small-Cell Lung Cancer accounts for approximately 85% of all cases of lung cancer. Non-Small Cell Lung Cancer generally grows and spreads more slowly than small cell lung cancer. There are three main types of Non-Small Cell Lung Cancer named for the type of cells in which the cancer develops: 1. squamous cell carcinoma (also called epidermoid carcinoma), 2. adenocarcinoma. 3. large cell carcinoma.

The international staging system for lung cancer (1986) describes tumors in terms of their characteristic appearances.

For example:
T0 designates no evidence of primary tumor;
Tx designates a tumor proven by the presence of malignant cells in bronchopulmonary secretions but not visualized roentgenographically or bronchoscopically, or any tumor that cannot be assessed as in a retreatment staging;
TIS designates a carcinoma in situ;
T1 designates a tumor that is 3.0 cm or less in greatest dimension surrounded by lung or visceral pleura, and without evidence of invasion proximal to a lobar bronchus at bronchoscopy;
T2 designates a tumor more than 3.0 cm in greatest dimension, or a tumor of any size that either invades the visceral pleura or has associated atelectasis or obstructive pneumonitis extending to the hilar region. At bronchoscopy, the proximal extent of demonstrable tumor must be within a lobar bronchus or at least 2.0 cm distal to the carina. Any associated atelectasis or obstructive pneumonitis must involve less than an entire lung;
T3 designates a tumor of any size with direct extension into the chest wall (including superior sulcus tumors), diaphragm, or the mediastinal pleura or pericardium without involving the heart, great vessels, trachea, oesophagus or vertebral body, or a tumor in the main bronchus within 2 cm of the carina without involving carina;
T4 designates a tumor of any size with invasion of the mediastinum or involving the heart, great vessels, trachea, oesophagus or vertebral body or carina or presence of malignant pleural effusion;
A2 designates nodal involvement (N);
N0 designates an absence of demonstrable metastasis to regional lymph nodes;
N1 designates metastasis to lymph nodes in the peribronchial or the ipsilateral hilar region, or both, including direct extension;
N2 designates metastasis to ipsilateral mediastinal lymph nodes and subcarinal lymph nodes;
N3 designates metastasis to contralateral medistinal lymph nodes, contralateral hilar lymph nodes, ipsilateral or contralateral scalene or supraclavicular lymph nodes;
A3 designates distant metastasis (M);
M0 designates an absence of known distant metastasis;
M1 designates that distant metastasis is present and the site(s) should be specified.

The above classification system is used to track the onset and development of lung cancer, with five stages being generally referred to: Stage I, Stage II, Stage IIIA, Stage IIIB and Stage IV, in increasing order of severity. See Table 1.

TABLE 1
The stages of lung cancer from diagnosis to death.

| Stage I | Stage II | Stage IIIA | Stage IIIB | Stage IV |
|---|---|---|---|---|
| T1 N0 M0 | T1 N1 M0 | T3 N0 M0 | any TN3M0 | any T any N |
| T2 N0 M0 | T2 N1 M0 | T3 N0 M0 | T4 any N M0 | M1 |
| | | T1-3N2M0 | | |

Surgery is the generally preferred treatment for stages I, II and a limited group of patients with stage IIIA disease, in which complete resection is feasible. Acceptance of the surgical procedure has been supported by the encouraging survival data. Five-year survival, which remains below 15% for lung cancer generally, exceeds 70% after resection of the T1N0 subgroup of stage I NSCLC [A population based study of lung cancer and benign inthrathoracic tumors. 1999. Report of the University of Oulu, Finland]. On the other hand, patients with stage I Non-Small-Cell Lung Cancer without surgery based on data collected in screening programs, had only a five-year survival rate of 2% (Flehinger et al. 1992).

Although surgery for lung cancer carries a 5% overall operative mortality risk and causes significant morbidity, it nevertheless remains the most successful treatment method for patients with squamous cell carcinoma, adenocarcinoma and large cell carcinoma, although it has little to offer in cases of small-cell cancer owing to the disseminated nature of this cancer type. Radiotherapy and chemotherapy are also widely used, particularly where surgery is not an option.

The success of all treatment methods increases dramatically with early diagnosis. The main diagnosis means is X-ray imaging. The patient's chest is irradiated with X-rays and the variation in intensity of transmitted X-rays or reflected X-rays depends on the amount of matter in the path between X-ray emitter and detector, i.e. the quantity and type of body tissue. The more matter present, the brighter the image. By using pixilated arrays of solid state photon detectors operating on the photoelectric effect, it is possible to get high resolution, digitized gray scale images, where the lighter the gray, the more tissue is present.

One advantage of digitizing X-ray images is the ease of storage of images, and the ease of data transmission making the possibility of real time international consulting a reality. Computer-assisted radiology can also be used for diagnostic purposes; however, diagnosis requires that systems be carefully designed so that they supply sufficient data for the development of decision support systems. This requirement has rarely been considered when implementing radiology information systems.

Although the human eye can differentiate only several levels of grayness, state of the art computerized techniques using 2 KB grayscale, divide the gray spectrum from black to white into six thousand levels. With this depth of image, it is theoretically possible to detect and characterize lung nodules, tumors and other features, but to do so is exceedingly complicated since any shade of gray in an X-ray image of the chest cavity is affected by all body tissue between emitter and detector, including skin, breast tissue, lungs, ribs, muscle, etc.

Although most of the CAD systems existing in the literature for lung cancer concentrate on CT images and 3D representation, computer-aided diagnosis (CAD) systems for X-ray images of CR and DR have been proposed by the DEUS Company and have also been the subject of several university projects. The Deus system, known as RapidScreen™ 2000 is described in detail in DEUS Technologies, LLC, Premarket Approval Documentation for RapidScreen™ RS2000, 2000.

CAD systems for lung analysis are based essentially on five basic processing steps:
(1) Segmentation of the Lung, see K O. J. P. and Naidich D. P. “Computer—Aided Diagnosis and the Evaluation of Lung Disease” Journal Thorac. Imaging 2004; Vol. 19: 136-155, for example.
(2) Location of tumor candidates by using adaptive filters such as ring filter and others, see ibid, and Freedman M. T., Lo S.-C. B., Lure F., Xu X-W, Lin J., Osicka T., Zhao H. and Zhang R. “A Computer Aid for Radiologists: Improved Detection of Small Volume Lung Cancer on CR and DR Chest Radiographs.

Deus Technology.
(3) Extraction of the boundaries of tumor candidates,
(4) Extraction of feature parameters, and
(5) Discrimination between the normal and the abnormal regions using classifiers.

Several image-processing techniques have been used in chest radiography analysis. These include histograms, subtraction techniques, segmentation of lung fields and CI filters.

Chest radiographs inherently display a wide dynamic range of X-ray intensities. In conventional, unprocessed images it is often hard to “see through” the mediastinum and contrast in the lung fields is limited. A classical solution to this kind of problem in image processing is the use of (local) histogram equalization techniques. A related technique is enhancement of high frequency details (sharpening).

Subtraction techniques attempt to remove normal structures in chest radiographs so that abnormalities stand out more clearly, either for the radiologist to see or for computer analysis to detect.

One approach is temporal subtraction [Computer analysis of chest radiographs: a Review Chapter 2] wherein a previous radiograph of the same patient is registered with the current image and an elastic matching technique is employed in which the displacement of small ROls is computed based on cross-correlation and a smooth deformation field is obtained by fitting a high order polynomial function to the displacement vectors. The registered image is subtracted and if the registration is successful, areas with interval change appear as either dark or bright on a gray background. The original technique has been improved and evaluated by using subjective ratings of the quality of the subtraction image as determined by radiologists.

Since chest X-rays include other features apart from lung tissue, it is necessary to detect and discount features not related to lung tissue, such as the outer ribcage, the diaphragm and the costophrenic angle where the diaphragm and the rib cage meet.

Kundel et al. in Optimization of chest radiography, HHS Publication (FDA), 80-8124, Rockville, Md., 1980, introduced the concept of conspicuity to describe those properties of an abnormality and its surround which either contribute to or distract from its visibility. Kelsey et al. in the same publication investigated factors which affect the perception of simulated lung tumors and found that the visibility of lesions varied with their location on chest radiographs. Thus, a computerized search scheme would have to be capable of locating nodules that have varying degrees of conspicuity (i.e., nodules immersed in backgrounds of various anatomic complexity).

Pixel classification techniques are based on convergence index filters (CI filters). One such filter type, adaptive ring filters, has been used to extract tumor candidates by evaluating the degree of convergence of gradient vectors to the pixel of interest, see Ko and Naidich. The output of this filtering technique does not depend on the contrast of the region of interest to its background. In their study, Ko and Naidich claim that they found highly ranked local peaks of the outputs of the adaptive ring filter correspond to the summit of tumors. In their work, the top 25 peaks on each X-ray image were detected as the tumor candidate location. At each tumor candidate location, the boundary of the candidate was estimated by using a two-step process. In the first step, Iris filter, which is another kind of CI filter, was used to estimate the fuzzy boundary. Then, SNAKES algorithm was applied to the output image of the Iris filter to obtain the boundary of the tumor candidate. Feature parameters were calculated for each sub region found. The discrimination between the normal and the abnormal regions was performed using a statistical method based on the Maharanobis distance measure.

Using pixel classification techniques such as the above, allows features to be extracted from each multi-resolution image using various kinds of filtering or transformation such as Fourier transform, Wavelet transform, spatial difference, Iris filtering, adaptive ring filtering, and the like. It will be appreciated however, that transforming images in such manners give rise to various kinds of features, including features of interest, noise, features from other depths, and artifacts of the imaging technique. Indeed, the total number of features extracted from multi-scale images and transformations thereof run into the several hundred. For diagnosis it is necessary to identify nodules and to classify them as either benign or cancerous. This requires identifying a far smaller list of features, and the present invention is directed to applying such a narrow list of features and thereby to provide a method for detecting and characterizing tumors by which the performance of a CAD system can be vastly improved.

U.S. Pat. No. 4,907,156 to Doi, et al. incorporated herein by reference, describes a method and system for enhancement and detection of abnormal anatomic regions in a digital image for detecting and displaying abnormal anatomic regions existing in a digital X-ray image, wherein a single projection digital X-ray image is processed to obtain signal-enhanced image data with a maximum signal-to-noise ratio (SNR) and is also processed to obtain signal-suppressed image data with a suppressed SNR. Then, difference image data are formed by subtraction of the signal-suppressed image data from the signal-enhanced image data to remove low-frequency structured anatomic background, which is basically the same in both the signal-suppressed and signal-enhanced image data. Once the structured background is removed, feature extraction, is performed. For the detection of lung nodules, pixel thresholding is performed, followed by circularity and/or size testing of contiguous pixels surviving thresholding. Threshold levels are varied, and the effect of varying the threshold on circularity and size is used to detect nodules. For the detection of mammographic microcalcifications, pixel thresholding and contiguous pixel area thresholding are performed. Clusters of suspected abnormalities are then detected.

U.S. Pat. No. 5,463,548 to Asada, et al. incorporated herein by reference, describes a method and system for differential diagnosis based on clinical and radiological information using artificial neural networks, specifically a method and system for computer-aided differential diagnosis of diseases, and in particular, computer-aided differential diagnosis using neural networks. A first embodiment of the neural network distinguishes between a plurality of interstitial lung diseases on the basis of inputted clinical parameters and radiographic information. A second embodiment distinguishes between malignant and benign mammographic cases based upon similar inputted clinical and radiographic information. The neural networks were first trained using a hypothetical data base made up of hypothetical cases for each of the interstitial lung diseases and for malignant and benign cases. The performance of the neural network was evaluated using receiver operating characteristics (ROC) analysis. The decision performance of the neural network was compared to experienced radiologists and achieved a high performance comparable to that of the experienced radiologists. The neural network according to the invention can be made up of a single network or a plurality of successive or parallel networks. The neural network according to the invention can also be interfaced to a computer which provides computerized automated lung texture analysis to supply radiographic input data in an objective and automated manner.

M. L. Giger in “Computerized Scheme for the Detection of Pulmonary Nodules”, Image Processing VI, IEEE Engineering in Medicine & Biology Society, 11. sup. The Annual International Conference (1989), incorporated herein by reference, describes a computerized method to detect locations of lung nodules in digital chest images. The method is based on a difference-image approach and various feature-extraction techniques, including a growth test, a slope test, and a profile test. The aim of the detection scheme is to direct the radiologist's attention to locations in an image that may contain a pulmonary nodule, in order to improve the detection performance of the radiologist.

U.S. Pat. No. 6,078,680 to Yoshida et al. incorporated herein by reference, describes a method and apparatus for discrimination of nodules and false positives in digital chest radiographs, using a wavelet snake technique. The wavelet snake is a deformable contour designed to identify the boundary of a relatively round object. The shape of the snake is determined by a set of wavelet coefficients in a certain range of scales. Portions of the boundary of a nodule are first extracted using a multi-scale edge representation. The multi-scale edges are then fitted by a gradient descent procedure which deforms the shape of a wavelet snake by changing its wavelet coefficients. The degree of overlap between the fitted snake and the multi-scale edges is calculated and used as a fit quality indicator for discrimination of nodules and false detections.

In general, certain diseases, e.g., cancer, can form nodules (i.e., abnormal, often rounded growths) in body tissues. Detection of such nodules (which can be, e.g., malignant or benign tumors) may be of great importance for diagnosis of the disease, particularly in lung cancer. Although X-radiographs (i.e., X-ray images) have, in some cases, proven successful in detecting the nodules, studies have shown that radiologists attempting to diagnose lung disease by visual examination of chest radiographs can fail to detect pulmonary i.e., lung, nodules in up to 30% of actually abnormal cases were such nodules are present.

Furthermore, conventional techniques for computerized detection of pulmonary nodules suffer from detection of “false positives”, i.e., spurious detection of nodules that do not actually exist. In conventional systems, reduced rates of false positive detection cannot typically be achieved without reducing the sensitivity of detection of actual nodules still further. Consequently, operating a conventional system at a sensitivity sufficiently high for clinical use has the drawback that the number of false positives can be undesirably high. In fact, some conventional systems, if operated at acceptably high sensitivity, can produce from 5 to 10 false positives per image.

Therefore, there is a need for an apparatus and method which can maintain a high sensitivity of detection of actual nodules in biological tissue, while reducing the rate of spurious detection. In particular, increased accuracy of pulmonary nodule detection is important for correct diagnosis of lung disease.

There is a need to improve the efficiency, i.e. both the throughput and accuracy, of CAD techniques for the analysis of nodules in x-ray chest radiographs for medical diagnostic applications, and embodiments of the present invention address this need.

### SUMMARY OF THE INVENTION

It is an aim of the invention to improve the throughput and accuracy of CAD techniques.

It is a specific aim of embodiments of the invention, to provide improved CAD techniques for the identification of nodules in body organs, particularly in lungs from chest x-ray radiographs.

The present invention is directed to providing a method of identifying nodules in radiological images, said method comprising: obtaining a radiological image; selecting sub-images centered around candidate locations; dividing each sub-image into a rectangular array of cells; calculating absolute values of Intensity Differences id₍ₖ₎ according to a Fractional Brownian Motion (FBM) calculation equation:

$${id}_{( k )} = [ \begin{matrix}\frac{{\sum }_{x = 0}^{N - 1} {\sum }_{y = 0}^{N - k - 1} \vert I ( x , y ) - I ( x , y + k ) \vert}{4 N ( N - k )} + \\ \frac{{\sum }_{y = 0}^{N - 1} {\sum }_{x = 0}^{N - k - 1} \vert I ( x , y ) - I ( x + k , y ) \vert}{4 N ( N - k )} + \\ \frac{{\sum }_{x = 0}^{N - 1 - k} {\sum }_{y = 0}^{N - k - 1} \vert I ( x , y ) - I ( x + k , y + k ) \vert}{4 {( N - k )}^{2}} + \\ \frac{{\sum }_{x = 0}^{N - 1 - k} {\sum }_{y = 0}^{N - k - 1} \vert I ( x , N - y ) - I ( x + k , N - ( y + k ) ) \vert}{4 {( N - k )}^{2}}\end{matrix} ]$$

for k=1 to s; calculating a NFBM feature, f₍ₖ₎, for each id₍ₖ₎, such that: f₍ₖ₎=log(id₍ₖ₎)−log(id₍₁₎; integrating f₍ₖ₎, over k=1 to s; classifying the cells into intensity contrast classes, according to intensity contrast between each cell and its neighbors, and result of the integration; remapping each cell of the sub-image according to its contrast class, and determining shape of region in the sub-image comprising high-contrast cells, wherein an annular shaped region of cells having high contrast with their neighbors is indicative of a nodule.

Optionally, there are two intensity classes and the cells are classified into high and low intensities to provide a binary image.

In some embodiments, this may include calculating the average intensity of the cells; classifying the cells with a classifier, as low intensity, and high intensity, relative to the average intensity; remapping each cell in the sub-image according to intensity class, and determining the shape of the region of high-intensity cells in the sub-image, wherein a circular shape is indicative of a nodule.

In some embodiments, a feature may be used based on the fact that a substantially circular and substantially smooth interior region surrounded with an annular rough region as being indicative of a nodule.

Typically, the radiological image is a posterior anterior chest x-ray radiograph. Optionally, the classifying is by a k-means algorithm.

Optionally, the method further comprising additional steps of providing a training set of images, comprising ground truth candidate locations; calculating Sclass1, Sclass2, and Sclass3, wherein Sclass1 is the relative amount of cells having both low contrast class and high intensity class, out of all cells in the array; Sclass2 is the relative amount of high contrast class, and Sclass3 is the amount of cells having both low intensity contrast class and low intensity class in a remapped sub-image, and (q) calculating at least one derived feature selected from the group comprising:

$$N F B {M}_{1} = \frac{Sclass 2}{Sclass 3} , \\ N F B {M}_{2} = \frac{Sclass 1}{Sclass 3} , \\ N F B {M}_{3} = \frac{Sclass 1}{Sclass 2} , \\ N F B {M}_{4} = \frac{Sclass 1}{( Sclass 1 + Sclass 2 + Slass 3 )} , \\ N F B {M}_{5} = \frac{Sclass 2}{( Sclass 1 + Sclass 2 + Slass 3 )} , \\ N F B {M}_{6} = \frac{Sclass 3}{( Sclass 1 + Sclass 2 + Slass 3 )} ;$$

wherein Sclass1 represents relative area coverage of cells belonging to smooth interior of the sub-image; Sclass2 relates to boundary region, and Sclass3 relates to exterior region of sub image as classified by employing the k-means algorithm on the intensity contrast and intensity of the cells; incorporating the at least one derived feature into a CAD system, and optimizing said CAD system by incorporating NFBM values providing highest sensitivity of said classifier. Optionally, the incorporated values comprise at least three of NFBM₁, NFBM₂, NFBM₅, and FBM₆.

Typically, the incorporated values comprise NFBM₁, NFBM₂, NFBM₅, and FBM₆.

Typically, the candidate location is suspected of being indicative of a nodule.

A second aspect is directed to provide a CAD system for detecting nodules from radiological images, said system comprising a classifier programmed for identifying nodules by at least one feature selected from the group comprising: NFBM₁, NFBM₂, NFBM₃, NFBM₄, NFBM₅ and NFBM₆.

A third aspect of the invention is directed to providing a CAD system for detecting nodules from radiological images, said system comprising a classifier programmed for identifying nodules by at least one features selected from the group comprising:

$$\begin{matrix}N F B {M}_{1} = \frac{Sclass 2}{Sclass 3} ; & ( i ) \\ N F B {M}_{2} = \frac{Sclass 1}{Sclass 3} ; & ( ii ) \\ N F B {M}_{3} = \frac{Sclass 1}{Sclass 2} ; & ( iii ) \\ N F B {M}_{4} = \frac{Sclass 1}{( Sclass 1 + Sclass 2 + Slass 3 )} & ( iv ) \\ N F B {M}_{5} = \frac{Sclass 2}{( Sclass 1 + Sclass 2 + Slass 3 )} ; & ( v ) \\ N F B {M}_{6} = \frac{Sclass 3}{( Sclass 1 + Sclass 2 + Slass 3 )} & ( vi )\end{matrix}$$

wherein Sclass1 represents relative area coverage of cells belonging to smooth interior of the sub-image; Sclass2 relates to boundary region, and Sclass3 relates to exterior region of sub image as classified by employing a k-means algorithm on the intensity contrast and intensity of the cells.

Typically, the CAD system enables identifying nodules by at least two features selected from the group comprising: NFBM₁, NFBM₂ NFBM₃, NFBM₄, NFBM₅, and NFBM₆.

More typically, the CAD system enables identifying nodules by at least three features selected from the group comprising: NFBM₁, NFBM₂, NFBM₃, NFBM₄, NFBM₅, and NFBM₆.

Optionally, the CAD system includes at least four features selected from the group comprising: NFBM₁, NFBM₂, NFBM₃, NFBM₄, NFBM₅, and NFBM₆ and may be sued for detecting nodules in chest x-ray radiographs. It will be noted that techniques of the present invention may be combined with other methods of processing images and other nodule related features of the prior art. X-ray images and localized sub-images may be characterized by texture, namely the contrast or distribution and range of intensities within the image. An image with a large range of intensities in at least part of the image is referred to herein as having a rough texture, and one having a small range is referred to as having a smooth texture.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

FIG. 1a shows a sub image extracted from a chest radiograph, divided into an array of cells by overlapping a 6×6 grid thereover;

FIG. 2 is a schematic illustration demonstrating graphically the intensity difference calculation, performed on a square compared to neighboring cells;

FIG. 3. is a flowchart detailing a method for detecting nodules according to one embodiment of the invention;

FIG. 4a is an x-ray radiograph of the chest region of a patient, showing the right and left lungs, spine and position of the heart;

FIG. 4b is a corresponding lung segmentation mask showing candidate nodules;

FIG. 5(a) is a sub-image of FIG. 4a; FIG. 5(b) is the corresponding cluster after applying the k-means algorithm to the image of FIG. 5(a); FIGS. 6(1) to 6(6) are exemplary sub images having various textures;

FIGS. 7(1) to 7(6) are corresponding Normalized Fractal Brownian Motion (NFBM) curves for the subimages 6(1) to 6(6);

FIG. 8 is a graph showing false positives versus sensitivity statistics for Receiver Operating Characteristics (ROC) obtained by manual and CAD analysis of a test set of x-ray radiographs, demonstrating the improved performance of the CAD system when further optimized by using non-biased roughness features in accordance with an embodiment of the invention.

### DESCRIPTION OF THE EMBODIMENTS

In general, the Computer-Aided Diagnosis processes for nodule determination are based on the three main steps of lung segmentation, nodules detection and features computation and filtration based on the nodule features; the present invention is particularly directed to providing novel features computation. In general, lung computerized radiography (CR), digitized radiography (DR) or digitized film (DF) imaging will have already been performed and collected by the time treatment strategy is defined and executed for particular patients. In general, the clinical criteria for selecting nodules as malignant is based on a library of radiography data obtained from digital lung X-rays of adults, where a frontal digital DR image of the lung is obtained, and either: (i) the radiography is determined as being negative, i.e. without nodules, by a certified radiologist; (ii) one or more detected nodules are diagnosed as being probably benign by a certified radiologist, due to granuloma hamartoma, adenoma (including carcinoid tumor), or fibrocystic change, for example; or (iii) more nodules are suspected by a certified radiologist as displaying some type of carcinoma, such as, but not limited to: primary lung carcinoma (epithelial tumors, mucoepidermic carcinoma, adenoid cystic carcinoma, carcinosarcoma) metastases (malignant melanoma) or others (such as malignant lymphomas or soft tissue tumors), for example.

There is a particular problem that rib crosses in the x-ray radiograph may be confused for nodules, and edges of blood vessels may also look nodular.

Embodiments of the present invention relate to methods for defining and computing texture features and location-related features for aiding in the classification of candidate regions as nodules or as false positives. This has been found to contribute to the effectiveness of Computer Aided Diagnosis (CAD) of anterior posterior x-ray radiographs and the description hereinbelow relates to the specific application of automated analysis of chest x-ray radiographs for detecting nodules therein, as useful for diagnosing lung cancer. It will be appreciated however, that with simple modifications as will be evident to the man of the art, the basic concepts and processes described hereinbelow may be applied to other body organs, such as thyroid glands, for example.

Embodiments of the present invention are directed to an improved method of image processing of lung radiographs in which selected sub areas identified as candidate regions with suspected nodules are mapped according to intensity contrast. The image processing typically includes a Normalized Fractional Brownian Motion (NFBM) method, which has various advantages. Notably, NFBM does not require a priori input from a user, thereby eliminating user bias. It is also fast. The method provides candidate features that appear to correlate to lung nodules and may thus be used in computer aided diagnosis for the classification of abnormalities such as nodules in x-ray radiography images, and may improve the accuracy of existing systems.

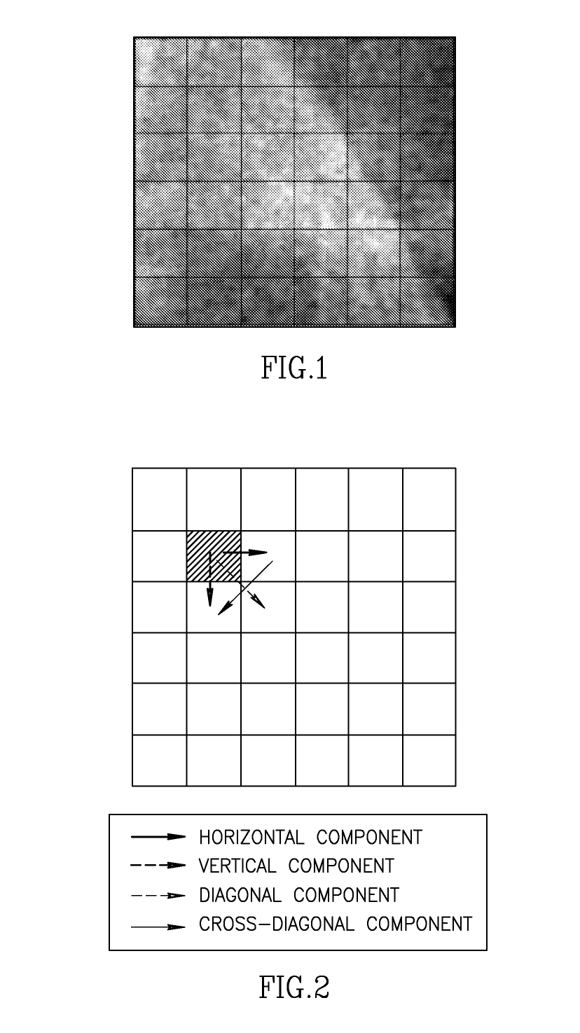

As shown in FIG. 1, in essence, the method includes identifying sub areas of x-ray radiographs suspected as including possible nodules referred to hereinbelow as candidate locations. Each sub area including a candidate location is then itself divided into an array of equal sized sub-regions, henceforth cells, such as by superimposing a grid thereover. As illustrated in FIG. 2, applying the NFBM method on the cells of the grid, includes calculating, for each and every cell thereof, the intensity differences between that cell and neighboring cells in a region proximal thereto. The size of the region for which the comparison is carried out is increased in an incremental manner by a Brownian motion type random walk algorithm, until the region encompasses the entire sub-image. A particular feature of the random walk approach is that it eliminates human bias. Further calculations on the intensity difference-based results provide an indication of the shape of cell aggregations in the image section, enabling classification of the candidate as being or not being a nodule.

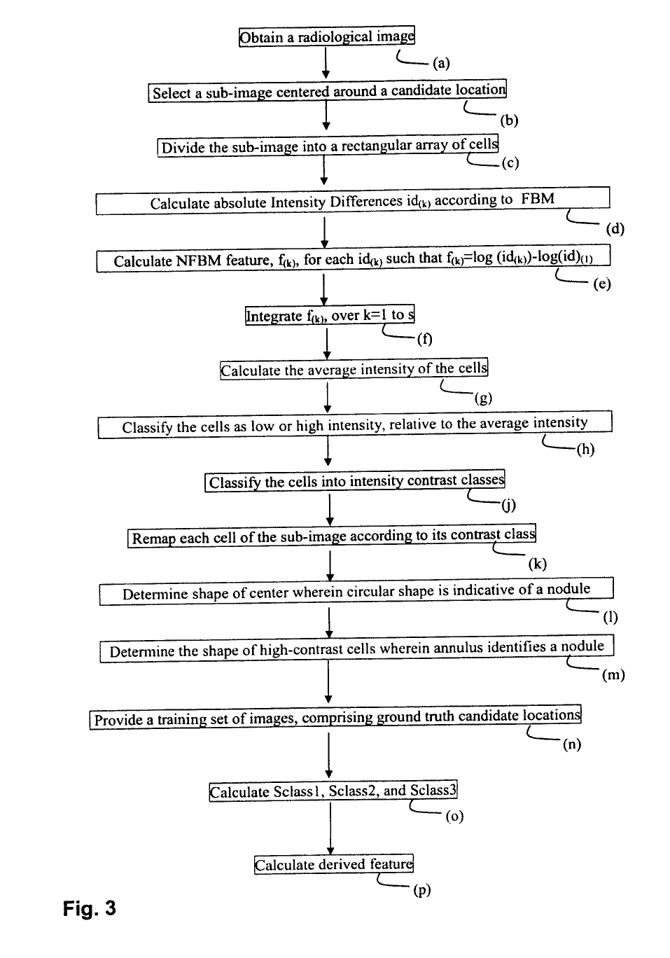

With reference to FIG. 3, a method of improved processing of lungs radiographs in accordance with an embodiment of the invention consists of:

(a) Obtaining a lung radiograph;

(b) Generating candidate regions;

(c) Defining sub-images centered on each candidate;

(d) Dividing each sub-image into an array of cells;

(d) calculating the absolute values of the Intensity Differences id₍ₖ₎ between k-distanced cells in accordance with a Fractional Brownian Motion (FBM) calculation, for k=1 to s, wherein k is the distance in cell units between pairs of cells, and s is the maximal scale as follows:

$${id}_{( k )} = [ \begin{matrix}\frac{{\sum }_{x = 0}^{N - 1} {\sum }_{y = 0}^{N - k - 1} \vert I ( x , y ) - I ( x , y + k ) \vert}{4 N ( N - k )} + \\ \frac{{\sum }_{y = 0}^{N - 1} {\sum }_{x = 0}^{N - k - 1} \vert I ( x , y ) - I ( x + k , y ) \vert}{4 N ( N - k )} + \\ \frac{{\sum }_{x = 0}^{N - 1 - k} {\sum }_{y = 0}^{N - k - 1} \vert I ( x , y ) - I ( x + k , y + k ) \vert}{4 {( N - k )}^{2}} + \\ \frac{{\sum }_{x = 0}^{N - 1 - k} {\sum }_{y = 0}^{N - k - 1} \vert I ( x , N - y ) - I ( x + k , N - ( y + k ) ) \vert}{4 {( N - k )}^{2}}\end{matrix} ]$$

(e) Calculating the NFBM feature, f₍ₖ₎, for each id₍ₖ₎, such that: f₍ₖ₎=log(id₍ₖ₎)−log(id₍₁₎

(f) Integrating f₍ₖ₎, over k=1 to s;

(i) classifying the cells into at least two intensity contrast classes, according to intensity contrast between each cell and nearby cells in the sub-image, and the integration result

(k) Remapping each cell of the sub-image according to the intensity contrast class, and

(m) Determining the shape of the region of the sub-image including cells having high-contrast with their neighbors, i.e. the rough area.

Lung nodules are typically almost spherical. After preprocessing, they typically appear in x-ray radiographs as white circular regions with low contrast, surrounded by an annular region of high contrast (roughness) class. Features extracted from the processed sub image are compared with features describing this model, to provide an indication as to whether the sub-image includes a nodule or not.

Preferably, the method further includes:

(g) Calculating the average intensity of the cells;

(h) Classifying the cells, as low intensity, and high intensity, relative to an average intensity value;

(j) Remapping the sub image into a binary image of cells, where each cell is either classified as high intensity or low intensity, and

(l) Determining the shape of the region of high-intensity cells in the sub-image, wherein circularity is indicative of nodules.

Nodules typically appear as annular regions of high contrast around interior circular regions of high but fairly constant intensity, i.e. low contrast, with the area surrounding the nodules typically appearing as having low intensity and low variation in contrast. The of the sub image may be remapped according to the classifications of both intensity contrast with the average intensity of the image (whiteness or relative intensity) and local variation in intensity as compared with its neighbors (roughness), to facilitate detection of nodules.

Classification of the cells may be carried out by cluster analysis techniques such as by the k-means algorithm, for example

The “k-means algorithm” is an algorithm to cluster n objects based on attributes into k partitions, k<n. It assumes that the object attributes form a vector space. The algorithm aims for minimal total intra-cluster variance:

$$V = {\sum }_{i = 1}^{k} {\sum }_{{x}_{j} ∈ {S}_{i}} {( {x}_{j} - {μ}_{i} )}^{2}$$

where there are k clusters Sᵢ, i=1, 2, . . . , k, and μᵢ is the centroid or mean point of all the points xⱼ in Sᵢ.

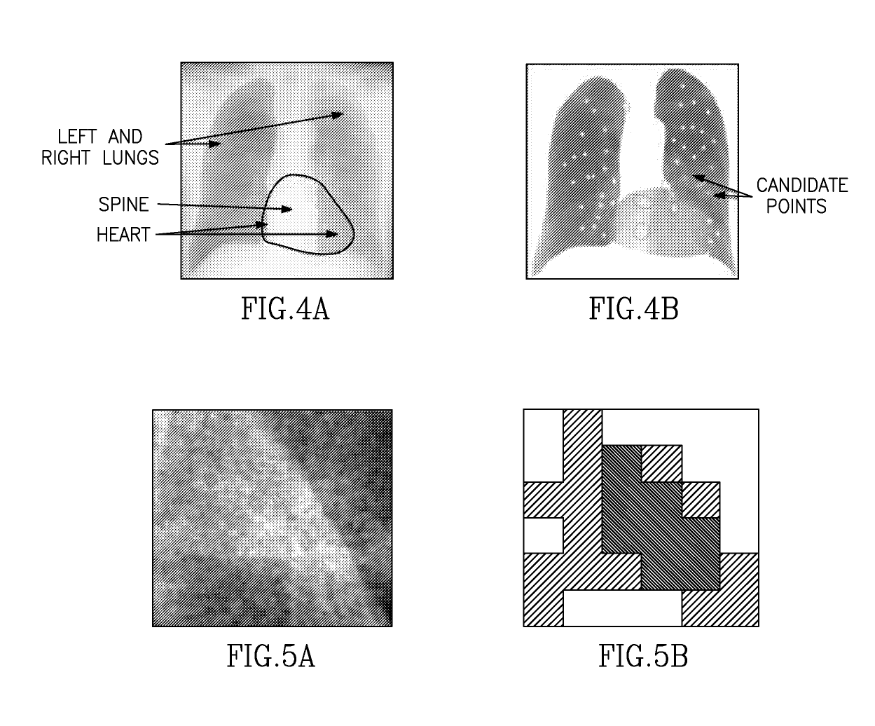

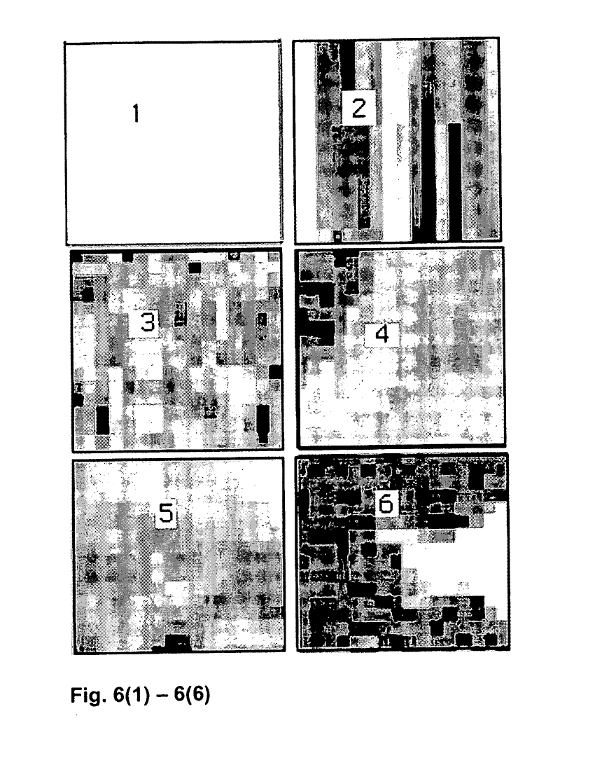

The approach is illustrated with reference to FIGS. 5a and 5b, wherein FIG. 5a shows a sub-image of FIG. 4, and FIG. 5b shows the corresponding clusters obtained after employing the k-means algorithm on the cells and mapping the results back onto the sub-image.

### EXAMPLES

### Example 1

### NFBM Feature Curves Obtained from Textural Regions

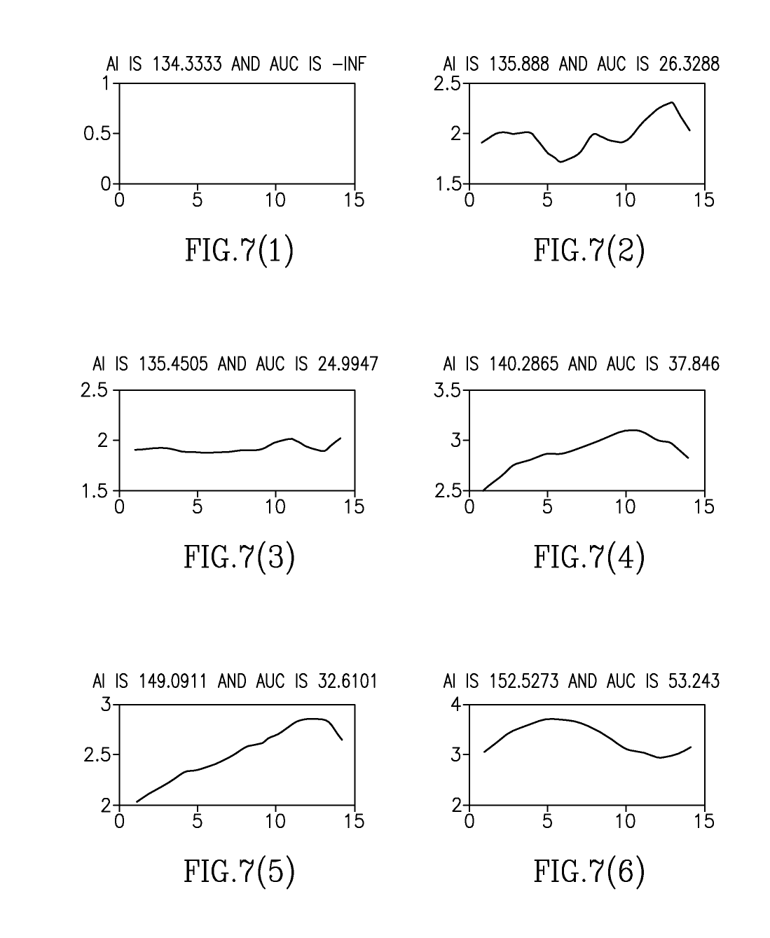

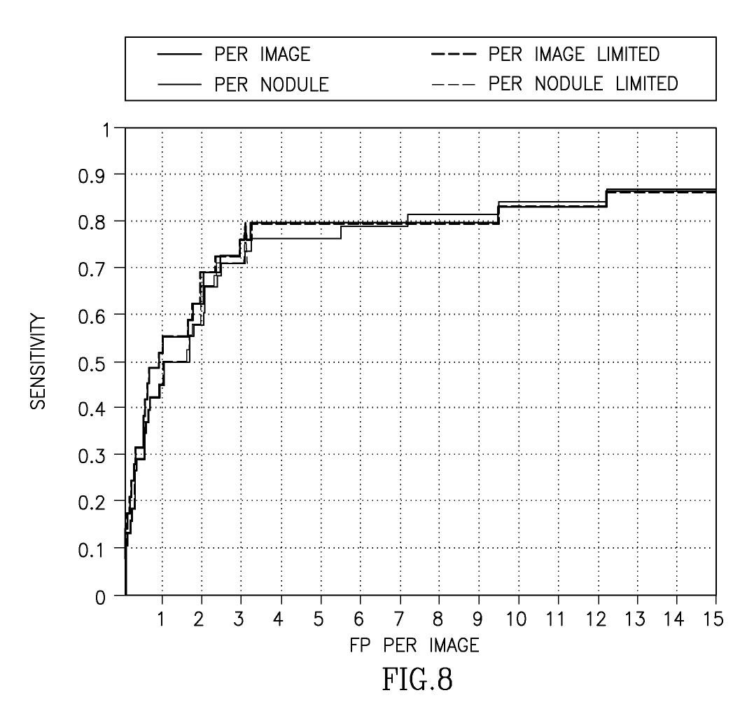

With reference to FIGS. 6(1) to 6(6), six separate sub-images were selected, to demonstrate how sub images having different textures can be differentiated by average intensity and texture analysis by integration, i.e. consideration of the area under the curve obtained, to identify nodules according to the NFBM method. Each sub-image was divided into an array of 16×16 cells. FIG. 6(1) is a uniformly smooth region, characterized by a uniform intensity. FIG. 6(2) has a regularized textural pattern, made of parallel strips, each strip having a relatively uniform intensity but a different intensity from adjacent strips. Such an image might correspond to the border of an organ having a thickness and thus total x-ray absorption that tapers off towards the edge, for example. FIGS. 6(3), 6(4) and 6(5) appear to be composed of cells with random distributions of intensities. The NFBM based results for each of the corresponding six sub-images are illustrated in FIGS. 7(1) to 7(6), where corresponding curves of f₍ₖ₎ against k are shown. Comparing the data above each curve, Average Intensity (AI) and Area Under Curve (AUC), there appears to be a direct relationship between the roughness of the texture and the AUC. For example, the AUC is infinity for FIG. 6(1), as f(k) is a negative logarithm of zero, whereas the highest AUC is obtained from the NFBM calculation of FIG. 6(6), which has a rough texture that is clearly visible to the eye. It will be noted that FIG. 6(6) has a practically identical average intensity as compared to FIG. 6(5), which visibly has less roughness than FIG. 6(6) and has a correspondingly lower AUC. It will be apparent therefore, that the AUC is a promising indicator of roughness of an image section and may itself be used as a feature, or incorporated in derivative features for nodule identification, since roughness is indicative of nodules, as described hereinabove.

### Example 2

### Identification of a Nodule in a Lung from a Chest Radiograph

A data set consisting of 150 lung segmentation maps from different individuals was obtained. The average resolution was 0.143 mm, 2700×2700 pixels with 12-bit intensity contrast. Each map was manually diagnosed by three radiologists to minimize bias, and the data set was segregated into a training group of 100 maps which was used to develop classification algorithms and a test group of 50 maps which were used to test the algorithms. Manual diagnosis (ground truth) of the training set showed 16 lung radiographs that were clear of nodules and 84 radiographs showing one or more nodules, with 165 nodules in total being detected. The test group was also analyzed manually, and 8 cases were found to be clear of nodules, with a total of 64 nodules being found in the other 42 cases. Candidates detected in the maps were marked as being suspect nodules and classified along a nominal scale of visibility from 1 to 5, where 1 corresponds to “hardly detectable” and 5 indicates “easily detectable” nodules. The nodules were fairly evenly distributed across the groups.

In the training set, sub-images centered on each of the candidate locations were selected.

Six NFBM features were integrated into an existing CAD system for lung nodule detection in chest X-rays, which included 13 previously determined statistical and geometrical features already in use for characterizing sub-images for nodule extraction. Examples of possible prior art features may be found in the citations in the Background section, for example.

The NFBM features were:

$$\begin{matrix}N F B {M}_{1} = \frac{Sclass 2}{Sclass 3} ; & ( i ) \\ N F B {M}_{2} = \frac{Sclass 1}{Sclass 3} ; & ( ii ) \\ N F B {M}_{3} = \frac{Sclass 1}{Sclass 2} ; & ( iii ) \\ N F B {M}_{4} = \frac{Sclass 1}{( Sclass 1 + Sclass 2 + Slass 3 )} ; & ( iv ) \\ N F B {M}_{5} = \frac{Sclass 2}{( Sclass 1 + Sclass 2 + Slass 3 )} ; & ( v ) \\ N F B {M}_{6} = \frac{Sclass 3}{( Sclass 1 + Sclass 2 + Slass 3 )} & ( vi )\end{matrix}$$

Where Sclass1 represents the relative area coverage of the cells belonging to the smooth interior region in the remapped sub-image; Sclass2 is related to the rough boundary, and Sclass3 is related to the smooth exterior region, all classified by employing the k-means algorithm on the intensity contrasts and intensities of the cells.

The CAD system, which included a nodule candidate generator, detected 7465 nodule candidates for the training group, and each was labeled with a malignancy value.

A relevance vector machine (RVM) based nodule classifier was designed, based on the manual diagnoses of the 3 radiologists. A leave-one-out method was employed to evaluate the performance of each combination of NFBM features. As a result, the four NFBM features NFBM₁, NFBM₂, NFBM₅, and NFBM6 were determined as giving significant additional sensitivity. For selected images with suspected nodules given a visibility rating of over 3.5, the 13 preprogrammed prior art features of the CAD system gave a classifier sensitivity of 69.2%, and modification by further consideration of the features NFBM₁, NFBM₂, NFBM₅ and NFBM₆ features to those 13, gave an increased sensitivity of 75.9%. In addition, the false positive per image was reduced from 4.1 to 3.5. The Receiver Operating Characteristics (ROC) for the test group with and without the NFBM features is shown in FIG. 7.

Persons skilled in the art will appreciate that the present invention is not limited to what has been particularly shown and described hereinabove. Rather the scope of the present invention is defined by the appended claims and includes combinations of some of the features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method of identifying nodules in radiological images, said method comprising:
(a) obtaining a radiological image;
(b) selecting sub-images centered around candidate locations;
(c) dividing each sub-image into a rectangular array of cells;
(d) calculating absolute values of Intensity Differences id₍ₖ₎ according to a Fractional Brownian Motion (FBM) calculation equation:
$${id}_{( k )} = [ \begin{matrix}\frac{{\sum }_{x = 0}^{N - 1} {\sum }_{y = 0}^{N - k - 1} \vert I ( x , y ) - I ( x , y + k ) \vert}{4 N ( N - k )} + \\ \frac{{\sum }_{y = 0}^{N - 1} {\sum }_{x = 0}^{N - k - 1} \vert I ( x , y ) - I ( x + k , y ) \vert}{4 N ( N - k )} + \\ \frac{{\sum }_{x = 0}^{N - 1 - k} {\sum }_{y = 0}^{N - k - 1} \vert I ( x , y ) - I ( x + k , y + k ) \vert}{4 {( N - k )}^{2}} + \\ \frac{{\sum }_{x = 0}^{N - 1 - k} {\sum }_{y = 0}^{N - k - 1} \vert I ( x , N - y ) - I ( x + k , N - ( y + k ) ) \vert}{4 {( N - k )}^{2}}\end{matrix} ]$$
for k=1 to s;
(e) calculating a NFBM feature, f₍ₖ₎, for each id₍ₖ₎, such that: f₍ₖ₎=log(id₍ₖ₎)−log(id₍₁₎
(f) integrating f₍ₖ₎, over k=1 to s;
(i) classifying the cells into intensity contrast classes, according to intensity contrast between each cell and its neighbors, and result of the integration;
(k) remapping each cell of the sub-image according to its contrast class, and
(m) determining shape of region in the sub-image comprising high-contrast cells, wherein an annular shaped region of cells having high contrast with their neighbors is indicative of a nodule.

2. The method of claim 1, wherein there are two intensity classes and the cells are classified into high and low intensities to provide a binary image.

3. The method of claim 1 further comprising:
(g) calculating the average intensity of the cells;
(h) classifying the cells with a classifier, as low intensity, and high intensity, relative to the average intensity;
(j) remapping each cell in the sub-image according to intensity class, and
(l) determining the shape of the region of high-intensity cells in the sub-image, wherein a circular shape is indicative of a nodule.

4. The method of claim 1, wherein a substantially circular and substantially smooth interior region surrounded with an annular rough region is indicative of a nodule.

5. The method of claim 1, wherein said radiological image is a posterior anterior chest x-ray radiograph.

6. The method of claim 1, wherein the classifying is by a k-means algorithm.

7. The method of claim 1, further comprising additional steps:
(o) providing a training set of images, comprising ground truth candidate locations;
(p) calculating Sclass1, Sclass2, and Sclass3, wherein Sclass1 is the relative amount of cells having both low contrast class and high intensity class, out of all cells in the array; Sclass2 is the relative amount of high contrast class, and Sclass3 is the amount of cells having both low intensity contrast class and low intensity class in a remapped sub-image;
(q) calculating at least one derived feature selected from the group comprising:
$$\begin{matrix}N F B {M}_{1} = \frac{Sclass 2}{Sclass 3} ; & ( i ) \\ N F B {M}_{2} = \frac{Sclass 1}{Sclass 3} ; & ( ii ) \\ N F B {M}_{3} = \frac{Sclass 1}{Sclass 2} ; & ( iii ) \\ N F B {M}_{4} = \frac{Sclass 1}{( Sclass 1 + Sclass 2 + Slass 3 )} ; & ( iv ) \\ N F B {M}_{5} = \frac{Sclass 2}{( Sclass 1 + Sclass 2 + Slass 3 )} ; & ( v ) \\ N F B {M}_{6} = \frac{Sclass 3}{( Sclass 1 + Sclass 2 + Slass 3 )} & ( vi )\end{matrix}$$
wherein Sclass1 represents relative area coverage of cells belonging to smooth interior of the sub-image; Sclass2 relates to boundary region, and Sclass3 relates to exterior region of sub image as classified by employing the k-means algorithm on the intensity contrast and intensity of the cells;
(r) incorporating the at least one derived feature into a CAD system;
(s) optimizing said CAD system by incorporating NFBM values providing highest sensitivity of said classifier.

8. The method of claim 7, wherein the incorporated values comprise at least three of NFBM₁, NFBM₂, NFBM₅, and FBM₆.

9. The method of claim 7, wherein the incorporated values comprises NFBM₁, NFBM₂, NFBM₅, and FBM₆.

10. The method of claim 1, wherein the candidate location is suspected of being indicative of a nodule.

11. A CAD system for detecting nodules from radiological images, said system comprising a classifier programmed for identifying nodules by at least one feature selected from the group comprising: NFBM₁, NFBM₂, NFBM₃, NFBM₄, NFBM₅, and NFBM₆.

12. A CAD system for detecting nodules from radiological images, said system comprising a classifier programmed for identifying nodules by at least one features selected from the group comprising:
$$\begin{matrix}N F B {M}_{1} = \frac{Sclass 2}{Sclass 3} ; & ( i ) \\ N F B {M}_{2} = \frac{Sclass 1}{Sclass 3} ; & ( ii ) \\ N F B {M}_{3} = \frac{Sclass 1}{Sclass 2} ; & ( iii ) \\ N F B {M}_{4} = \frac{Sclass 1}{( Sclass 1 + Sclass 2 + Slass 3 )} ; & ( iv ) \\ N F B {M}_{5} = \frac{Sclass 2}{( Sclass 1 + Sclass 2 + Slass 3 )} ; & ( v ) \\ N F B {M}_{6} = \frac{Sclass 3}{( Sclass 1 + Sclass 2 + Slass 3 )} & ( vi )\end{matrix}$$
wherein Sclass1 represents relative area coverage of cells belonging to smooth interior of the sub-image; Sclass2 relates to boundary region, and Sclass3 relates to exterior region of sub image as classified by employing a k-means algorithm on the intensity contrast and intensity of the cells.

13. The CAD system of claim 12 for identifying nodules by at least two features selected from the group comprising: NFBM₁, NFBM₂ NFBM₃ NFBM₄, NFBM₅ and NFBM₆.

14. The CAD system of claim 12 for identifying nodules by at least three features selected from the group comprising: NFBM₁, NFBM₂ NFBM₃ NFBM₄, NFBM₅, and NFBM₆.

15. The CAD system of claim 12 for identifying nodules by at least four features selected from the group comprising: NFBM₁, NFBM₂, NFBM₃, NFBM₄, NFBM₅ and NFBM₆.

16. The CAD system of claim 12 for detecting nodules in chest x-ray radiographs.
